(19) United States
(12) Patent Application Publication
(10) Pub. No.: US 2026/0364684 A1
(43) Pub. Date: Nov. 19, 2026

(54) ADDITIVE MANUFACTURING MACHINE FOR MANUFACTURING ANNULAR PARTS

(71) Applicant: ADDUP, CEBAZAT (FR)

(72) Inventor: Albin EFFERNELLI, CLERMONT-FERRAND CEDEX 09 (FR)

(21) Appl. No.: 19/135,288

(22) PCT Filed: Dec. 5, 2023
(86) PCT No.: PCT/EP2023/084310

§ 371 Date: Jul. 2, 2025

(30) Foreign Application Priority Data
Dec. 8, 2022 (FR) FR2212966

(51) Int. Cl. B22F 12/30; B22F 12/63; B22F 12/67; B33Y 30/00

(52) U.S. Cl. CPC B22F 12/30; B22F 12/63; B22F 12/67; B33Y 30/00

(57) ABSTRACT

The invention relates to an additive manufacturing machine (10) for additive manufacturing by deposition of layers of powder and selective consolidation of these layers of powder, the machine (10) comprising a device (18) for depositing layers of powder, a working plane (12), a selective consolidation zone (14), a main jacket (42) of outer contour (Cex), and a secondary jacket (46) arranged inside the main jacket (42) and defining a non-manufacturing zone (48) inside the selective consolidation zone, the device (18) for depositing layers of powder comprising a powder distribution device (22) and a powder spreading device (24), the secondary jacket (42) is closed at the top by a flat closure wall parallel to the working plane (12) of the machine, and the powder spreading device (24) moves in translation above the selective consolidation zone (14) along a rectilinear movement axis (DR).

### TECHNICAL FIELD OF THE INVENTION

The present invention relates to an additive manufacturing machine by deposition of layers of powder and selective consolidation of these layers of powder.

More specifically, the invention is aimed at additive manufacturing by deposition of layers of powder and selective consolidation of large parts with a hollow central part, for example fixed parts of turbojet engines such as housing, stators, etc.; or rotating parts of turbojet engines such as turbine discs, etc.

When manufacturing parts with a hollow center with an additive manufacturing machine equipped with a cylindrical or parallelepipedic manufacturing jacket, there is a large central volume in the manufacturing jacket wherein no portion of the part is consolidated. As a result, this central volume is unnecessarily filled with powder.

To overcome this drawback, additive manufacturing machines with annular manufacturing jackets have been designed. Thanks to the annular shape of their manufacturing jackets, these machines can manufacture large parts with a hollow central part, while limiting powder consumption.

### DESCRIPTION OF THE PRIOR ART

Document EP 3300819 relates to a machine for manufacturing annular parts by selective powder fusion, the machine comprising an inner annular wall and an outer annular wall which are concentric and delimit an annular powder deposition zone. For spreading layers of powder, the machine comprises a powder distributor rotatable about the axis of the inner and outer annular walls, this powder distributor comprising a scraper extending between the inner and outer annular walls at a predefined angle to the radial direction of the inner and outer annular walls. Thanks to the angle formed by the scraper with respect to the radial direction, excess powder is discharged laterally towards the inside or outside of the annular zone.

A first drawback is that the rotary powder distributor described in EP 3300819 has relatively complex kinematics, which will require extensive testing before it can be validated for use in a manufacturing cycle. For example, due to its rotational movement, the scraper's speed is not identical at every point along its length: it is minimal at its inner end and maximum at its outer end. Moreover, different additive manufacturing powders have different flow characteristics. Consequently, for each type of powder, the best compromise must be found between the maximum speed of the scraper at its outer end and the minimum speed of the scraper at its inner end. In addition, the angle of the scraper in relation to the radial direction must be adjusted at each powder change.

### SUMMARY OF THE INVENTION

The aim of the present invention is to remedy these drawbacks of the prior art by proposing a configuration of an additive manufacturing machine that enables powder consumption to be limited when manufacturing parts with a hollow central part, and that can be easily and quickly operated.

To this end, the object of the invention is an additive manufacturing machine by deposition of layers of powder and selective consolidation of these layers of powder, the machine comprising a device for depositing layers of powder and a source for selective consolidation of the layers of powder, the machine comprising a working plane and a selective consolidation zone of the layers of powder located in this working plane, the machine comprising a main jacket opening into the working plane via an opening defining the outer contour of the selective consolidation zone, the machine comprising a secondary jacket disposed inside the main jacket and defining a non-manufacturing zone inside the selective consolidation zone, the machine comprising a build tray moving in translation between the main jacket and the secondary jacket under the effect of an actuator, and the powder layer deposition device comprising a powder distribution device and a powder spreading device, such as a roller or scraper, above the selective consolidation zone.

According to the invention, the secondary jacket is closed at the top by a flat closure wall parallel to the machine working plane, and the powder spreading device moves in translation above the selective consolidation zone along a rectilinear movement axis.

Advantageously, but not necessarily, the invention may also provide that:
the powder spreading device extends in a transverse direction perpendicular to its rectilinear movement axis,
the length of the powder spreading device in the transverse direction is greater than the maximum dimension of the outer contour of the selective consolidation zone in this transverse direction,
the powder distribution device enables a powder bead to be fed or deposited onto the working plane between the selective consolidation zone and the powder spreading device when the powder spreading device is in a waiting position outside the selective consolidation zone,
the powder distribution device comprises a powder-receiving surface movable relative to the working plane and the selective consolidation zone,
the powder distribution device comprises a powder reservoir that can be moved above the working plane,
the upper surface of the secondary jacket closure wall lies in the same plane as the upper surface of the working plane,
the build tray comprises a closed-contour opening through which the secondary jacket passes,
the secondary jacket is identical in shape to the main jacket in a horizontal plane, but homothetically reduced,
the secondary jacket and the main jacket are cylindrical and extend in a vertical direction,
the secondary jacket and the main jacket are coaxial.

### DESCRIPTION OF DRAWINGS

Further features and advantages of the invention will become apparent in the following description. This description, which is given by way of example and is not limitative, refers to the attached drawings wherein:

FIG. 1 shows a schematic top view of a machine according to the invention with a first variant of a powder distribution device,

FIG. 2 shows a schematic side view of a machine according to the invention with a second variant of a powder distribution device.

### DETAILED DESCRIPTION OF THE INVENTION

The invention relates to an additive manufacturing machine by deposition of layers of powder and selective consolidation of these layers of powder.

Additive manufacturing by deposition of layers of powder and selective consolidation is an additive manufacturing method wherein one or more parts are manufactured by the selective consolidation of different layers of additive manufacturing powder superimposed on one another. The first layer of powder is deposited on a support such as a tray, then selectively consolidated using at least one consolidation source along a first section of the part or parts to be manufactured. Then, a second layer of powder is deposited on the first layer of powder which has just been consolidated, and this second layer of powder is selectively consolidated in its turn, and so on until the last layer of powder useful for manufacturing the last section of the part or parts to be manufactured.

In the context of the invention, an additive manufacturing powder is preferably metallic, but can also be non-metallic.

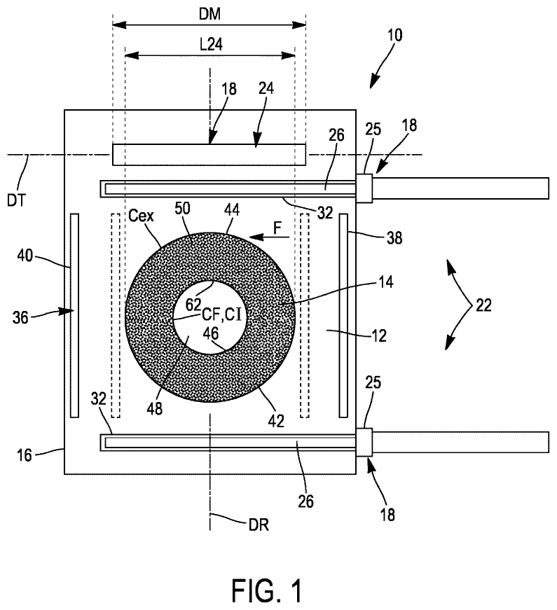

An additive manufacturing machine 10 by powder bed deposition and selective consolidation according to the invention is schematically shown in top view by FIG. 1.

This machine 10 comprises a working plane 12 and a selective consolidation zone 14 of the layers of powder located in this working plane. The working plane 12 and the selective consolidation zone 14 are preferably located in an enclosure 16 that can be sealably closed. One wall of this enclosure 16 may include a door giving access to the working plane 12 and the selective consolidation zone 14. The working plane 12 and the selective consolidation zone 14 preferably lie in a horizontal plane.

To implement additive manufacturing, machine 10 comprises a deposition device 18 of layers of powder and at least one source of selective consolidation 20 of the layers of powder.

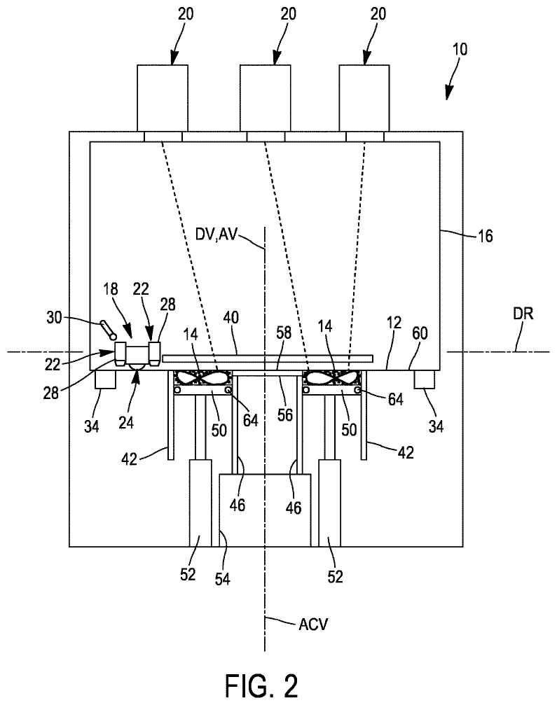

In the example shown in FIG. 2, the machine 10 comprises several selective consolidation sources 20. This plurality of selective consolidation sources is suitable for additive manufacturing of large parts in a large selective consolidation zone 14. In fact, the machine according to the invention is particularly intended for the manufacture of large parts, and preferably offers a large selective consolidation zone 14. Large parts are, for example, parts with an outside diameter greater than 35 centimeters and a height greater than 35 centimeters.

Preferably, each selective consolidation source 20 is a source emitting at least one laser beam for fusing at least part of a powder layer present in the consolidation zone 14. A laser source 20 includes, for example, a scanning head for moving the laser beam spot over at least part of the selective consolidation zone 14, and a device for managing the laser beam focus. Each source 20 can also include a device for monitoring the emitted laser beam and/or the melt bath created by the emitted laser beam in a layer of powder.

Alternatively, a selective consolidation source can also be a particle beam, such as an electron gun.

The device 18 for depositing layers of powder comprises a powder distribution device 22 and a powder spreading device 24, such as a roller or scraper, above the selective consolidation zone 14.

Preferably, the powder distribution device 22 is used to feed or deposit a powder bead onto the working plane 12 between the selective consolidation zone 14 and the powder spreading device 24 when the powder spreading device 24 is in a waiting position outside the selective consolidation zone, as shown in FIG. 1 for example.

In a first variant, the powder distribution device 22 comprises at least one powder distributor 25 and a powder-receiving surface 26 movable relative to the working plane 12 and the selective consolidation zone 14 and relative to the powder distributor 25. For example, powder distributor 25 comprises a powder reservoir mounted above a screw feeder. The movable receiving surface 26 moves under the powder distributor 25 to receive the powder delivered by distributor 25, which forms a bead of powder on this movable receiving surface. The receiving surface 26 is then positioned with its powder bead between the spreading device 24 and the selective consolidation zone 14, so that the spreading device 24 can spread the powder bead over the selective consolidation zone.

In the example shown in FIG. 1, the powder distribution device 22 comprises two distributors 25 arranged on either side of the selective consolidation zone 14, and two movable powder-receiving surfaces 26 arranged on either side of the selective consolidation zone. In this way, the powder spreading device 24 can spread a new layer of powder during each of its movements over the selective consolidation zone.

In a second variant, the powder distribution device 22 comprises at least one powder reservoir 28 that can be moved above the working plane 12. For example, a movable powder reservoir 28 is mounted on the powder spreading device 24. Preferably, and in order to deposit a powder bead in front of the spreading device, a powder reservoir 28 is mounted for translational movement relative to the spreading device 24. The powder distribution device 22 preferably comprises a powder inlet 30 in the enclosure 16 for replenishing powder in a mobile powder reservoir 28.

In the example shown in FIG. 2, the powder distribution device 22 comprises two mobile powder reservoirs 28 mounted on the spreading device, one on either side of the spreading device. In this way, a bead of powder can be deposited on each side of the spreading device, and the powder spreading device 24 can spread a new layer of powder during each of its movements over the selective consolidation zone 14.

In the first variant of powder distributor 22, each movable powder-receiving surface 26 is mounted so as to be movable in translation in a housing 32 provided in the working plane. Advantageously, this housing 32 allows excess powder to be recovered when a new layer of powder is applied to the selective consolidation zone.

In the second variant of the powder distribution device 22, at least one reservoir 34 for collecting excess powder is provided in working plane 12. Preferably, two reservoirs 34 for collecting excess powder are provided, one on each side of the selective consolidation zone 14.

Due to the fumes created by selective powder melting operations in the consolidation zone, machine 10 preferably includes a device 36 for collecting the fumes created by selective consolidation. This collection device 36 enables a flow of exhaust gas F to be generated above the selective consolidation zone. In more detail, the exhaust gas flow F circulates, for example, between an inlet ramp 38 located on one side of the consolidation zone 14 and an outlet ramp 40 located on the other side of the consolidation zone 14. For example, the collection device 36 comprises a device for generating the exhaust gas flow F and a fume filtration device (not shown in the figures) located in a circuit connected to the inlet and outlet ramps.

Advantageously, the inlet 38 and outlet ramps 40 can be moved in translation between a position dedicated to selective melting (shown as dotted lines in FIG. 1), where they are located as close as possible to the selective consolidation zone, and a position dedicated to powder layering (shown as solid lines in FIG. 1), wherein they are further away from the selective consolidation zone so as not to impede movements of the powder spreading device.

### Selective Consolidation Zone

According to the invention, and in particular with a view to manufacturing large parts with a hollow central part, the machine 10 comprises a main jacket 42 opening into the working plane 12 through an opening 44 defining the outer contour Cex of the selective consolidation zone 14, at least one secondary jacket 46 arranged inside the main jacket 42 and defining a non-manufacturing zone 48 inside the selective consolidation zone 14, and a build tray 50 moving in translation between the main jacket 42 and the secondary jacket 46 under the effect of at least one actuator 52. The non-manufacturing zone 48 is a sub-zone of the selective consolidation zone 14 wherein no selective powder consolidation takes place.

In a variant of the selective consolidation zone not shown in the figures, the machine 10 may comprise several secondary jackets 46 arranged within the main jacket 42 and defining several non-manufacturing zones 48 within the selective consolidation zone 14. In this case, the build tray 50 moves in translation between the main jacket 42 and the various secondary jackets 46.

In more detail, the main jacket 42 extends below the working plane 12. For example, the main jacket 42 is removably attached to the working plane 12. Each secondary jacket 46 also extends under the working plane 12. For example, each secondary jacket 46 is removably mounted on a support 54 integral with the frame of the machine 10. The main jacket 42 and the secondary jacket(s) 46 are removably mounted to facilitate their removal from the machine with the manufactured parts and the build tray 50, for example via the lower part of the machine.

The build tray 50 preferably moves in translation along a vertical axis AV corresponding to the vertical direction wherein the various layers of powder are superimposed. Preferably, several actuators 52 are used to move the build tray 50 relative to the main and secondary jackets. Advantageously, in addition to the actuator(s), the machine 10 can include means for guiding the build tray in translation (not shown).

According to the invention, and in order to limit powder consumption when manufacturing large parts with a hollow central part, each secondary jacket 46 is closed at the top by a flat closure wall 56 parallel to the working plane 12 of the machine.

In addition to the closure of the upper part of each secondary jacket, the powder spreading device 24 moves in translation above the selective consolidation zone 14 along a rectilinear movement axis DR. Coupled with the closure at the upper part of each secondary jacket, the rectilinear movement of the spreading device 24 makes it quick and easy to control the layering of the powder on the selective consolidation zone. Indeed, thanks to the rectilinear movement of the spreading device, the speed of the roller or scraper of the spreading device is identical over its entire length, and thanks to the closure at the upper part of each secondary jacket, the formation of a layer of powder takes place as if the selective consolidation zone 14 did not include a non-manufacturing zone.

Preferably, the rectilinear movement axis DR of the powder spreading device 24 is horizontal. Preferably, the rectilinear movement axis DR of the powder spreading device 24 is perpendicular to the fumes exhaust gas flow F. Preferably, the rectilinear movement axis DR of the powder spreading device 24 is perpendicular to the vertical axis AV of translation of the build tray 50.

### Spreading Device

Still with a view to easily and quickly controlling powder layering on the selective consolidation zone 14, the powder spreading device 24 extends in a transverse direction DT perpendicular to its rectilinear movement axis DR. More precisely, the roller or scraper of the powder spreading device 24 extends in a transverse direction DT perpendicular to its rectilinear movement axis DR.

In order to ensure that the powder layering is of uniform thickness over the entire surface of the selective consolidation zone 14, the length L24 of the powder spreading device 24 in the transverse direction DT is greater than the maximum dimension DM of the outer contour Cex of the selective consolidation zone 14 in this transverse direction DT. Preferably, and in order to avoid moving the inlet ramps 38 and outlet ramps 40 too far away from the consolidation zone 14, the length L24 of the powder spreading device 24 in the transverse direction DT is only a few millimeters greater than the maximum dimension DM of the outer contour Cex of the selective consolidation zone 14 in this transverse direction DT.

By extending over a length L24 greater than the maximum dimension DM of the outer contour Cex of the selective consolidation zone 14 in the transverse direction DT and moving along a rectilinear movement axis DR, the powder spreading device 24 offers easy-to-implement powder layering and higher deposition speed than a rotary powder distribution solution.

### Jackets and Tray

In a first preferred variant of the closure at the upper part of each secondary jacket, the upper surface 58 of the closure wall 56 of a secondary jacket 46 lies in the same plane as the upper surface 60 of the working plane 12. In this first variant, the upper surface 58 of the closure wall 56 of a secondary jacket 46 and the upper surface 60 of the working plane 12 lie a few tenths of a millimeter, for example 0.5 millimeters, below the generatrix of the roller or scraper of the spreading device 24. This prevents the roller or scraper from rubbing against the upper surface 58 of the closure wall 56 of a secondary jacket 46 and the upper surface 60 of the working plane 12. This space between the generatrix of the roller or scraper of the spreading device 24 and the upper surfaces of a closure wall 56 and the working plane 12 is filled with powder during the first powder layering and remains filled with powder until the end of manufacture.

In a second variant (not shown), the upper surface 58 of the closure wall 56 of a secondary jacket 46 lies very slightly above the plane of the upper surface 60 of the working plane 12, by a few tenths of a millimeter for example. In this second variant, the upper surface 58 of the closure wall 56 of a secondary jacket 46 always lies below the generatrix of the roller or scraper of the spreading device 24.

In a third variant (not shown), the upper surface 58 of the closure wall 56 of a secondary jacket 46 lies very slightly below the plane of the upper surface 60 of the working plane 12, by a few tenths of a millimeter for example. In this third variant, a significant powder thickness, of several tenths of a millimeter, must be formed by the spreading device 24 above a closure wall 56. This significant powder thickness is achieved at the start of the manufacturing cycle during the first powder layering, by distributing more powder in front of the spreading device 24 with the distribution device 22 than for subsequent powder layerings. Advantageously, the first layer of powder to be consolidated in the selective consolidation zone 14 is produced simultaneously with this significant powder thickness.

Ideally, a secondary jacket 46 is completely surrounded by the build tray 50. The build tray 50 also includes a closed-contour opening 62 CF through which the secondary jacket 46 passes. If several secondary jackets 46 are installed inside the main jacket 42, the build tray 50 comprises several openings 62 with a closed contour CF each of which is passed through by one of the secondary jackets 46.

In the example shown in the figures, the secondary jacket 46 is identical in shape to the main jacket 42 in a horizontal plane, but is homothetically reduced. For example, the main jacket 42 has a circular outer contour Cex and the inner contour CI of a secondary jacket 46 is also circular but with a diameter 1.01 to 10 times smaller, the inner contour CI of a secondary jacket 46 corresponding to the closed contour CF of the opening 62 provided in the tray 50 for this secondary jacket. However, the main jacket 42 and the secondary jacket(s) 46 can take different shapes, for example polygonal.

For the manufacture of annular parts, that is, with an axis of revolution, the secondary jacket 42 and the main jacket 46 are, for example, cylindrical and extend in a vertical direction DV parallel to the vertical axis AV of translation of the tray 50 and of superimposition of the powder layers. For example, the secondary jacket 46 and the main jacket 42 are coaxial around the same vertical central axis ACV.

In the present invention, the main jacket 42 and secondary jacket(s) 46 take the form of metal walls several millimeters thick, at least 15 to 20 millimeters thick.

Advantageously, to prevent powder leaks towards the lower part of the machine 10, sealing means 64, such as gaskets, can be provided between the build tray 50 and the main jacket 42 and secondary jacket(s) 46.

### Variants

Alternatively (not shown in the figures), the inlet ramp 38 and outlet ramp 40 of the fume collection device 36 can be located along the outer contour Cex of the selective consolidation zone 14 and the inner contour(s) CI of the secondary jacket(s). In a first example, the inlet ramp 38 is located along the outer contour Cex of the selective consolidation zone 14 and an outlet ramp 40 is located along the inner contour CI of a secondary jacket 46. In another example, an inlet ramp 38 is located along the inner contour CI of a secondary jacket 46 and an outlet ramp 40 is located along the outer contour Cex of the selective consolidation zone 14. In such a configuration, and when the selective consolidation zone 14 is annular, fumes exhaust gas flows F extend radially above the selective consolidation zone 14. Still in this configuration, the inlet 38 and outlet 40 ramps can be retracted, for example into the working plane 12 or raised several centimeters above the working plane 12, so as not to impede the movements of the powder spreading device.

1. Machine (10) for additive manufacturing by deposition of layers of powder and selective consolidation of these layers of powder, the machine (10) comprising a device (18) for depositing layers of powder and a source for selectively consolidating (20) the layers of powder, the machine comprising a working plane (12) and a selective consolidation zone (14) for layers of powder located in this working plane, the machine comprising a main jacket (42) opening into the working plane through an opening (44) defining the outer contour (Cex) of the selective consolidation zone, the machine comprising a secondary jacket (46) arranged inside the main jacket (42) and defining a non-manufacturing zone (48) inside the selective consolidation zone, the machine (10) comprising a build tray (50) moving in translation between the main jacket and the secondary jacket under the effect of an actuator (52), the powder layer deposition device (18) comprising a powder distribution device (22) and a powder spreading device (24), such as a roller or scraper, on the selective consolidation zone (14), the machine (10) being characterized in that the secondary jacket (42) is closed at the top by a flat closure wall (56) parallel to the machine working plane (12), and in that the powder spreading device (24) moves in translation above the selective consolidation zone (14) along a rectilinear movement axis (DR).

2. The additive manufacturing machine according to claim 1, wherein the powder spreading device (24) extends in a transverse direction (DT) perpendicular to its rectilinear movement axis (DR).

3. The additive manufacturing machine according to claim 2, wherein the length (L24) of the powder spreading device (24) in the transverse direction (DT) is greater than the maximum dimension (DM) of the outer contour (Cex) of the selective consolidation zone (14) in this transverse direction (DT).

4. The additive manufacturing machine according to one of the preceding claims, wherein the powder distribution device (22) enables a powder bead to be fed to or deposited on the working plane (12) between the selective consolidation zone (14) and the powder spreading device (24) when this powder spreading device is in a waiting position outside the selective consolidation zone (14).

5. The additive manufacturing machine according to claim 4, wherein the powder distribution device (22) comprises a powder-receiving surface (26) movable relative to the working plane (12) and to the selective consolidation zone (14).

6. The additive manufacturing machine according to claim 4, wherein the powder distribution device (22) comprises a powder reservoir (28) movable above the working plane.

7. The additive manufacturing machine according to one of the preceding claims, wherein the upper surface (58) of the closure wall (56) of the secondary jacket lies in the same plane as the upper surface (60) of the working plane (12).

8. The additive manufacturing machine according to one of the preceding claims, wherein the build tray (50) comprises an opening (62) with a closed contour (CF) through which the secondary jacket (46) passes.

9. The additive manufacturing machine according to claim 8, wherein the secondary jacket (46) is identical in shape to the main jacket (42) in a horizontal plane, but is homothetically reduced.

10. The additive manufacturing machine according to claim 9, wherein the secondary jacket (46) and the main jacket (42) are cylindrical and extend in a vertical direction (DV).

11. The additive manufacturing machine according to claim 10, wherein the secondary jacket (46) and the main jacket (42) are coaxial.
